(19) United States
(12) Patent Application Publication
(10) Pub. No.: US 2021/0237997 A1
(43) Pub. Date: Aug. 5, 2021

(54) TURNOVER TRAY

(71) Applicant: Wuhan China Star Optoelectronics Semiconductor Display Technology Co., Ltd., Wuhan, Hubei (CN)

(72) Inventor: Jian CHEN, Wuhan (CN)

(73) Assignee: Wuhan China Star Optoelectronics Semiconductor Display Technology Co., Ltd., Wuhan, Hubei (CN)

(21) Appl. No.: 16/496,461

(22) PCT Filed: Aug. 5, 2019
(86) PCT No.: PCT/CN2019/099168

§ 371 Date: Sep. 23, 2019

(51) Int. Cl. B65H 15/00; B25B 11/00

(52) U.S. Cl. CPC B65H 15/00; G02F 1/1303; B25B 11/005

(57) ABSTRACT

A turnover tray includes a tray body, at least one placement groove is disposed on a lateral surface of the tray body, and the placement groove is used for placing a glass cover plate. Further, when the glass cover plate is disposed in the placement groove, the glass cover plate is in a point contact or in a line contact with inner walls of the placement groove, and a hollow cavity is formed between the glass cover plate and the placement groove, thereby solving the phenomena of scratches on a surface of a glass cover plate and the problem of displacement occurring during a carrying process.

### FIELD OF INVENTION

The present disclosure relates to the field of display manufacture, and particularly relates to a turnover tray.

### BACKGROUND OF INVENTION

At present, when module bonding factories are involved inglass cover bonding plate processes, they will use turnover trays, and present designs of the turnover trays are universal trays designed according to a shape of panels after being cut. Their shape is much larger than the size of the glass cover, and a bottom of a cavity is a flat design. This kind of turnover trays will continue to be used in downstream processes, which will cause the following problems when products are turned over: the size of the turnover tray is far larger than the glass cover, which causes large gaps between peripheral sides after the glass cover is bonded to the tray for blanking. And after the tray is loaded, displacement and friction between a surface of the glass cover plate and the bottom of the tray occur, causing scratches in the process. Because the size of the turnover trays is too large, and products which are performed a deaeration process during subsequent process are loaded by the turnover tray, resulting in the position of the product to not be fixed, and the accuracy of the grasping center position of the deaeration machine cannot be guaranteed, which affects production and utilization of the machine.

Therefore, the prior art has drawbacks and is in urgent need to be improved.

### SUMMARY OF INVENTION

The present disclosure provides a turnover tray which can solve the problem of scratches on a surface of a glass cover plate and the problem of displacement occurring during a carrying process.

In order to solve the problems mentioned above, the present disclosure provides the technical solutions as follows:

The present disclosure provides a turnover tray, which includes a tray body, at least one placement groove is disposed on a lateral surface of the tray body, and the placement groove is used for placing at least one glass cover plate.

Further, when the glass cover plate is disposed in the placement groove, the glass cover plate is in a point contact or in a line contact with inner walls of the placement groove, and a hollow cavity is formed between the glass cover plate and the placement groove.

In the turnover tray of the present disclosure, four corners of the glass cover plate are in the point contact with the inner walls of the placement groove.

In the turnover tray of the present disclosure, four edges of the glass cover plate are in the line contact with the inner walls of the placement groove.

In the turnover tray of the present disclosure, an aperture size of the placement groove is gradually reduced from an opening section of the placement groove to a bottom section of the placement groove.

In the turnover tray of the present disclosure, the inner walls of the placement groove include a curved surface or an inclined surface.

In the turnover tray of the present disclosure, the inner walls of the placement groove include a stair structure.

In the turnover tray of the present disclosure, a predetermined included angle is formed between the two adjacent inner walls of the placement groove, making four edges of the glass cover plate be contacted with the inner walls of the placement groove.

In the turnover tray of the present disclosure, a gas suction port is disposed on a bottom section of the placement groove, and the gas suction port is connected to a gas suction device, the gas suction device is for inhaling gas from the hollow cavity, so that a pressure difference is formed on two sides of the glass cover plate to adsorb the glass cover plate into the placement groove.

In the turnover tray of the present disclosure, a valve is disposed on the gas suction port, and by controlling the valve to be closed or opened to maintain or cancel a negative pressure environment of the hollow cavity.

In order to solve problems mentioned above, the present disclosure further provides a turnover tray, which includes a tray body, at least one placement groove is disposed on a lateral surface of the tray body, and the placement groove is used for placing at least one glass cover plate.

Further, when the glass cover plate is disposed in the placement groove, the glass cover plate is in a point contact or in a line contact with inner walls of the placement groove, and a hollow cavity is formed between the glass cover plate and the placement groove; a concavity is disposed on at least one of inner walls of the placement groove, and the concavity is disposed along an extending direction of the inner wall; a gap is formed between the concavity and the glass cover plate, and a manipulator grasps the glass cover plate by passing through the concavity.

In the turnover tray of the present disclosure, four corners of the glass cover plate are in the point contact with the inner walls of the placement groove.

In the turnover tray of the present disclosure, four edges of the glass cover plate are in the line contact with the inner walls of the placement groove.

In the turnover tray of the present disclosure, an aperture size of the placement groove is gradually reduced from an opening section of the placement groove to a bottom section of the placement groove.

In the turnover tray of the present disclosure, the inner walls of the placement groove include a curved surface or an inclined surface.

In the turnover tray of the present disclosure, the inner walls of the placement groove include a stair structure.

In the turnover tray of the present disclosure, an included angle is formed between the two adjacent inner walls of the placement groove, making four edges of the glass cover plate be contacted with the inner walls of the placement groove.

In the turnover tray of the present disclosure, a gas suction port is disposed on a bottom section of the placement groove, and the gas suction port is connected to a gas suction device, the gas suction device is for inhaling gas from the hollow cavity, so that a pressure difference is formed on two sides of the glass cover plate to adsorb the glass cover plate into the placement groove.

In the turnover tray of the present disclosure, a valve is disposed on the gas suction port, and by controlling the valve to be closed or opened to maintain or cancel a negative pressure environment of the hollow cavity.

The beneficial effect of the present disclosure is that compared with existing turnover trays, the turnover tray provided by the present disclosure makes a surface contact between the glass cover and the placement groove change into a point contact or a line contact through improvement of the structure of the placement groove, thereby greatly reducing the contact area of the glass cover plate and the placement groove, so that the risk of the glass cover plate being scratched during a turnover process can be avoided to the utmost extent. In addition, the glass cover plate can be firmly stuck in the placement groove by its own weight, so displacement is not easy to occur during the turnover process, and blanking accuracy of subsequent processes is ensured.

### DESCRIPTION OF DRAWINGS

To more clearly illustrate embodiments or the technical solutions of the present disclosure, the accompanying figures of the present disclosure required for illustrating embodiments or the technical solutions of the present disclosure will be described in brief. Obviously, the accompanying figures described below are only part of the embodiments of the present disclosure, from which figures those skilled in the art can derive further figures without making any inventive efforts.

FIG. 1 is a structural schematic diagram of part of structure of a liquid crystal display panel provided by the first embodiment of the present disclosure.

FIG. 2 is a cross-sectional diagram along the cutting line A-A′ in FIG. 1.

FIG. 3 is a top view of a turnover tray provided by the second embodiment of the present disclosure.

FIG. 4 is a cross-sectional diagram along the cutting line A-A′ in FIG. 3.

FIG. 5 is a cross-sectional diagram of another turnover tray provided by the second embodiment of the present disclosure along the cutting line A-A′.

FIG. 6 is a top view of another turnover tray provided by the second embodiment of the present disclosure.

FIG. 7 is a top view of a turnover tray provided by the third embodiment of the present disclosure.

FIG. 8 is a cross-sectional diagram along the cutting line A-A′ in FIG. 7.

### DETAILED DESCRIPTION OF PREFERRED EMBODIMENTS

The descriptions of embodiments below refer to accompanying drawings in order to illustrate certain embodiments which the present disclosure can implement. The directional terms of which the present disclosure mentions, for example, “top,” “bottom,” “upper,” “lower” “front,” “rear,” “left,” “right,” “inside,” “outside,” “side,” etc., are just refer to directions of the accompanying figures. Therefore, the used directional terms are for illustrating and understanding the present disclosure, but not for limiting the present disclosure. In the figures, units with similar structures are used same labels to indicate.

The present disclosure aims at addressing the technical problem that a surface of a glass cover plate is easy to be scratched and displacement occurs during a carrying process. The present disclosure can overcome such defects.

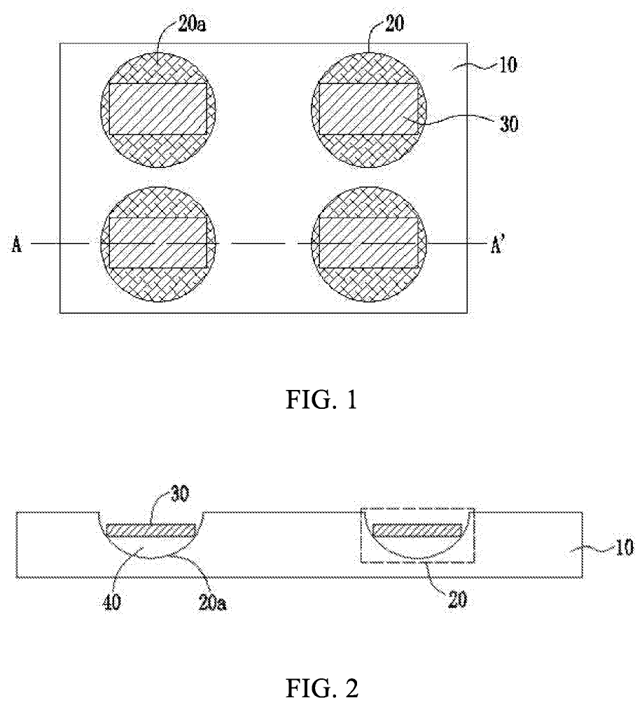

As illustrated in FIG. 1, it is a top view of a turnover tray provided by the first embodiment of the present disclosure. The turnover tray includes a tray body 10, at least one placement groove 20 is disposed on a lateral surface of the tray body 10. When a plurality of the placement grooves 20 are disposed on the tray body 10, a plurality of the placement grooves 20 can be regularly or irregularly distributed on the tray body 10. The placement grooves 20 are used for placing a glass cover plate 30. An area of an opening of the placement groove 20 is greater than an area of the glass cover plate 30, so that the glass cover plate 30 can be put into the placement groove 20 smoothly. Further, when the glass cover plate 30 is disposed in the placement grooves 20, four corners of the glass cover plate 30 and inner walls 20a of the placement grooves 20 form a point contact, and a hollow cavity is enclosed by the glass cover plate 30 and the inner walls 20a of the placement grooves 20 (as 40 illustrated in FIG. 2).

As illustrated in FIG. 2, it is a cross-sectional diagram along the cutting line A-A′ in FIG. 1. An aperture size of the placement groove 20 is gradually reduced from an opening section of the placement groove 20 to a bottom section of the placement groove, so that the glass cover plate 30 is fixed on the glass cover plate 30 and the inner walls 20a of the placement groove 20 and is not contacted to the bottom section of the placement groove. Moreover, by adopting this design, the glass cover plate 30 with different sizes can be fixed, thereby increasing utilization rate of the turnover tray. In figures, a shape of the placement grooves 20 is a hemispherical shape, but not limited thereto, as long as the inner wall 20a of the placement grooves 20 is a curved surface, such as an inverted conical shape, a shape of a frustum of an inverted cone.

The four corners of the glass cover plate 30 (if the glass cover plate is a notched structure, they are corners of the notched structure) are supported on the inner walls 20a of the placement grooves 20. Due to principle of the curved surface, that is, the glass cover plate 30 is placed at various angles in the placement groove 20, the hollow cavity 40 is always formed with the inner walls 20a of the placement groove 20, that is, even if the glass cover plate 30 is displaced or tilted in the placement groove 20, the glass cover plate 30 and the inner walls 20a of the placement groove 20 are always in a point contact, and therefore, the design minimizes the risk of scratches between the glass cover plate 30 and the placement groove 20.

In addition, due to the own weight of the glass cover plate 30, making the glass cover plate 30 placed in the placement groove 20 can be stably stuck in the placement groove 20, and displacement does not easily occur, thereby ensuring blanking accuracy of subsequent processes. Even though displacement or skew occurs during a turnover process, the glass cover plate 30 is relatively easy to return to a horizontal state after the turnover process is stopped due to the principle of curved surface and the factor of its own weight.

In an embodiment, because an aperture size of the placement groove 20 is gradually reduced from an opening section of the placement groove 20 to a bottom section of the placement groove 20, the glass cover plates 30 with at least two sizes can be placed in a same placement groove 20 in the same time, and a gap is between the adjacent two glass cover plates 30 to prevent from scratches occurring, thereby can further improve utilization rate of the turnover tray, and improving production efficiency.

In another embodiment, a layer of flexible layer can be disposed on the inner walls 20a of the placement grooves 20. When the glass cover plate 30 is placed in the placement groove 20, a concavity is formed on locations where the inner walls 20a contact to the four corners of the glass cover plate. Therefore, the glass cover plate 30 can be more stably stuck on the inner walls 20a so as displacement is not easy to occur.

In this embodiment, because a gap between peripheral sides of the glass cover plate 30 and the inner walls 20a is formed, the glass cover plate 30 is facilitated to be picked and placed.

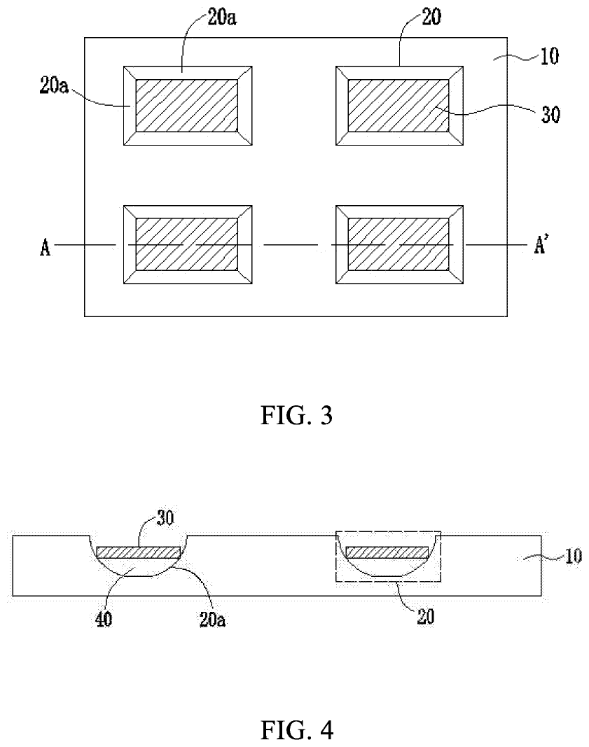

As illustrated in FIG. 3, it is a top view of a turnover tray provided by the second embodiment of the present disclosure. The difference between this embodiment and the first embodiment is that a shape of the openings of the placement groove 20 is a rectangular shape, but is not limited thereto, and may be specifically configured according to the shape of the cover glass 30. Further, a predetermined included angle is formed between the two adjacent inner walls 20a of the placement groove 20, making the peripheral sides of the glass cover plate 30 contact to the inner walls 20a of the placement groove 20, that is, the glass cover plate 30 is in a line contact with the placement groove 20. Further, the predetermined included angle between the two adjacent inner walls 20a can be configured according to an actual process, and is not limited herein. In this embodiment, the predetermined included angle is taken as 90° as an example.

Combining that illustrated in FIG. 4, the glass cover plate 30 and the inner walls 20a of the placement groove 20 enclose to form a hollow cavity 40, and the inner walls 20a of the placement grooves 20 are curved surface designs, so that the glass cover plate 30 is realized in a line contact with the inner walls 20a. The upper and bottom surfaces of the glass cover plate 30 are prevented from being scratched, and meanwhile the peripheral side walls of the glass cover plate 30 can be prevented from being scratched.

Because the glass cover plate 30 is in the line contact with the placement groove 20 only by the peripheral edges, the risk of scratches between the glass cover plate 30 and the placement groove 20 is greatly reduced. Further, since the peripheral edges of the glass cover plate 30 are in contact with the inner walls 20a, making the glass cover plate 30 placed in the placement groove 20 can be more stably stuck in the placement groove 20, and displacement does not easily occur, thereby ensuring blanking accuracy of subsequent processes.

In figures, the shape of the placement grooves 20 is a curve surface, but not limited thereto, and the inner walls 20a of the placement grooves 20 can also be inclined surface designs. In addition, a shape of the inner walls 20a of the placement grooves 20 includes but not limited to an inverted pyramid, and a frustum of an inverted pyramid, etc.

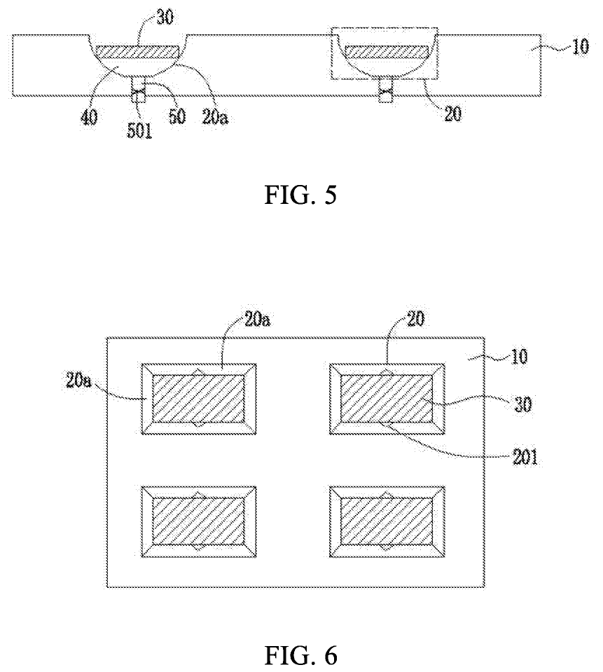

As illustrated in FIG. 5, it is a cross-sectional diagram of another turnover tray provided by the second embodiment of the present disclosure along the cutting line A-A′. Combining that illustrated in FIG. 3, because the peripheral sides of the glass cover plate 30 contact to the inner walls 20a of the placement groove 20, thereby the hermetic hollow cavity 40 being formed. Therefore, a gas suction port 50 is disposed on the bottom section of the placement groove 20, and the gas suction port 50 is connected to a gas suction device (not shown), the gas suction device is for inhaling gas from the hollow cavity 40, so that a pressure difference is formed on two sides of the glass cover plate 30 to adsorb the glass cover plate 30 into the placement groove 20.

Further, a valve 501 is disposed on the gas suction port 50, and by controlling the valve 501 to be closed or opened to maintain or cancel a negative pressure environment of the hollow cavity 40. That is, connecting the gas suction device to the gas suction port 50, and opening the valve 501 to inhale gas by a control terminal, makes the negative pressure environment be formed in the hollow cavity 40. After completed gas suction, the control terminal close the valve 501, and the gas suction device is detached from the gas suction port 50, making the hollow cavity 40 to maintain the negative pressure environment for a turnover operation. At this time, the glass cover plate 30 is stably adsorbed in the placement groove, and displacement will not occur. Through opening the valve 501 by the control terminal, making the hollow cavity 40 return to atmospheric pressure to take out the glass cover plates 30. Further, there is no limitation on the position and number of the gas suction port 50.

As illustrated in FIG. 6, it is a top view of another turnover tray provided by the second embodiment of the present disclosure. The difference between FIG. 6 and FIG. 3 is that a concavity 201 is disposed on at least one of the inner walls 20a of the placement groove 20, and the concavity 201 is disposed along an extending direction of the inner wall 20a; a gap is formed between the concavity 201 and the glass cover plate 30, and a manipulator grasps the glass cover plate 30 by passing through the concavity 201

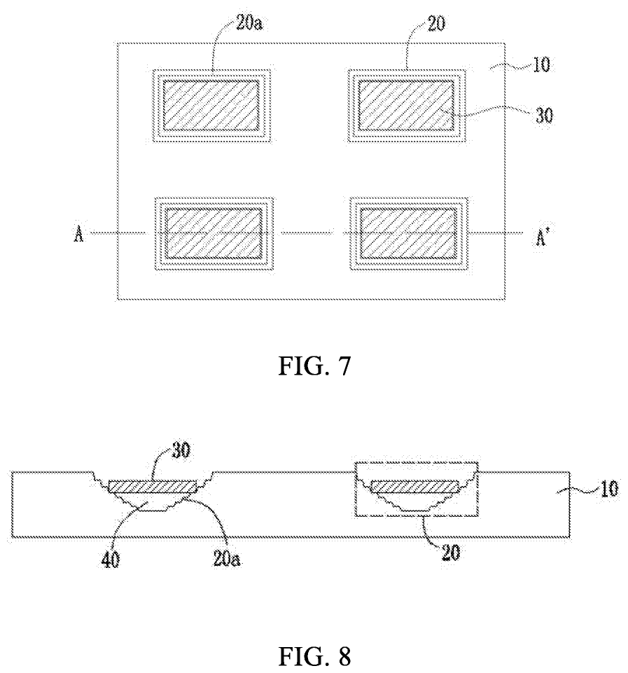

Combining that illustrated in FIG. 7 and FIG. 8, FIG. 7 is a top view of a turnover tray provided by the third embodiment of the present disclosure, and FIG. 8 is a cross-sectional diagram along the cutting line A-A′ in FIG. 7. The difference between this embodiment and the second embodiment is that the inner walls 20a of the placement groove 20 include a stair structure. Further, a predetermined included angle is formed between the two adjacent inner walls 20a of the placement groove 20, in figures, the predetermined included angle is 90°, but not is limited thereto, and makes four edges of the glass cover plate 30 contact with the inner walls 20a of the placement groove 20. The stair structure of the inner wall 20a can be designed according to an actual situation, so that the glass cover plate 30 is placed in the placement groove 20, and the peripheral edge of the glass cover plate 30 is just located on a position of one stair of the inner walls 20a, making the glass cover plate 30 is approximately in the line contact with the inner wall 20a. Because the hollow cavity 40 is formed between the glass cover plate 30 and the placement groove 20, the risk of scratches between the glass cover plate 30 and the placement groove 20 is greatly reduced. Moreover, because the glass cover plate 30 is suck at a certain stair of the inner wall 20a, making the glass cover plate 30 can be more stably placed in the placement groove 20, and displacement does not easily occur, thereby ensuring blanking accuracy of subsequent processes.

In addition, not only the glass cover plate can be placed on the turnover tray provided by the present disclosure, but also display panels, substrates, and other base material can be placed on the turnover tray.

In summary, the turnover tray provided by the present disclosure makes a surface contact between the glass cover and the placement groove be changed into a point contact or a line contact through improvement of the structure of the placement groove, thereby greatly reducing the contact area of the glass cover plate and the placement groove, so that the risk of the glass cover plate being scratched during a turnover process can be avoided to the utmost extent. In addition, the glass cover plates can be firmly stuck in the placement grooves by its own weight, so displacement is not easy to occur during a turnover process, and blanking accuracy of subsequent processes is ensured.

In summary, although the present disclosure has disclosed the preferred embodiments as above, however the above-mentioned preferred embodiments are not to limit to the present disclosure. A person skilled in the art can make any change and modification, therefore the scope of protection of the present disclosure is subject to the scope defined by the claims.

What is claimed is:

1. A turnover tray comprising:
a tray body, at least one placement groove disposed on a lateral surface of the tray body, the placement groove used for placing at least one glass cover plate;
wherein, when the glass cover plate is disposed in the placement groove, the glass cover plate is in a point contact or in a line contact with inner walls of the placement groove, and a hollow cavity is formed between the glass cover plate and the placement groove.

2. The turnover tray as claimed in claim 1, wherein four corners of the glass cover plate are in the point contact with the inner walls of the placement groove.

3. The turnover tray as claimed in claim 1, wherein four edges of the glass cover plate are in the line contact with the inner walls of the placement groove.

4. The turnover tray as claimed in claim 1, wherein an aperture size of the placement groove is gradually reduced from an opening section of the placement groove to a bottom section of the placement groove.

5. The turnover tray as claimed in claim 4, wherein the inner walls of the placement groove comprise a curved surface or an inclined surface.

6. The turnover tray as claimed in claim 4, wherein the inner walls of the placement groove comprise a stair structure.

7. The turnover tray as claimed in claim 5, wherein a predetermined included angle is formed between the two adjacent inner walls of the placement groove, making four edges of the glass cover plate be contacted with the inner walls of the placement groove.

8. The turnover tray as claimed in claim 1, wherein a gas suction port is disposed on a bottom section of the placement groove, and the gas suction port is connected to a gas suction device, the gas suction device is for inhaling gas from the hollow cavity, so that a pressure difference is formed on two sides of the glass cover plate to adsorb the glass cover plate into the placement groove.

9. The turnover tray as claimed in claim 8, wherein a valve is disposed on the gas suction port, and by controlling the valve to be closed or opened to maintain or cancel a negative pressure environment of the hollow cavity.

10. A turnover tray comprising:
a tray body, at least one placement groove disposed on a lateral surface of the tray body, the placement groove used for placing at least one glass cover plate;
wherein, when the glass cover plate is disposed in the placement groove, the glass cover plate is in a point contact or in a line contact with inner walls of the placement groove, and a hollow cavity is formed between the glass cover plate and the placement groove;
a concavity is disposed on at least one of the inner walls of the placement groove, and the concavity is disposed along an extending direction of the inner wall; a gap is formed between the concavity and the glass cover plate, and a manipulator grasps the glass cover plate by passing through the concavity.

11. The turnover tray as claimed in claim 10, wherein four corners of the glass cover plate are in the point contact with the inner walls of the placement groove.

12. The turnover tray as claimed in claim 10, wherein four edges of the glass cover plate are in the line contact with the inner walls of the placement groove.

13. The turnover tray as claimed in claim 10, wherein an aperture size of the placement groove is gradually reduced from an opening section of the placement groove to a bottom section of the placement groove.

14. The turnover tray as claimed in claim 13, wherein the inner walls of the placement groove comprise a curved surface or an inclined surface.

15. The turnover tray as claimed in claim 13, wherein the inner walls of the placement groove comprise a stair structure.

16. The turnover tray as claimed in claim 14, wherein a predetermined included angle is formed between the two adjacent inner walls of the placement groove, making four edges of the glass cover plate be contacted with the inner walls of the placement groove.

17. The turnover tray as claimed in claim 10, wherein a gas suction port is disposed on a bottom section of the placement groove, and the gas suction port is connected to a gas suction device, the gas suction device is for inhaling gas from the hollow cavity, so that a pressure difference is formed on two sides of the glass cover plate to adsorb the glass cover plate into the placement groove.

18. The turnover tray as claimed in claim 17, wherein a valve is disposed on the gas suction port, and by controlling the valve to be closed or opened to maintain or cancel a negative pressure environment of the hollow cavity.
